(19) United States
(12) Patent Application Publication
(10) Pub. No.: US 2005/0141097 A1
(43) Pub. Date: Jun. 30, 2005

(54) Color separation prism assembly

(75) Inventor: Fang-chuan Ho, Taoyuan County (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/019,356

(22) Filed: Dec. 23, 2004

(30) Foreign Application Priority Data
Dec. 26, 2003 (TW) 92137104

(51) Int. Cl. G02B 27/14; G02B 27/12

(52) U.S. Cl. 359/640

(57) ABSTRACT

A color separation prism assembly includes a first prism block and a second prism block. Two dichroic coatings each corresponding to a specific color band are respectively formed on two adjacent prism faces of the first prism block. The second prism block is in contact with both the prism faces of the first prism block having dichroic coatings and is constructed so that the angles of incidence to the dichroic coatings are all restricted within no more than 30 degrees, and that all split light components traveling in the prism assembly have equal optical path lengths.

### BACKGROUND OF THE INVENTION

(a) Field of the Invention

The present invention relates to a color separation prism assembly, and, more particularly, to a prism assembly applicable to a projection system for a TV camera or a color projection display.

(b) Description of the Related Art

FIG. 7 shows a conventional color separation prism that is generally referred to as a Philips prism. The Philips prism 100 separates an incoming light into three light components, namely the red (R), green (G) and blue (B). Referring to FIG. 7, the glass elements of the Philips prism includes three component prisms 102, 104 and 106. A dichroic coating 110 that reflects the red component and transmits blue and green components is deposited on a back face of the component prism 102, and a dichroic coating 108 that reflects the blue component and transmits the remaining green component is deposited between the component prism 104 and the component prism 106. An air gap 114 exists between the dichroic coating 110 and a front face of the component prism 104. As in FIG. 7, the dichroic coating 110 reflects the red component and transmits blue and green components as the incoming light I enters the Philips prism 100. The red component is further internally reflected by the component prisms 102 and illuminates a liquid crystal light valve (LCLV) 112R. Subsequently, the dichroic coating 108 reflects the blue component and transmits the green component. The blue component is further internally reflected by the component prism 104 and illuminates an LCLV 112B, while The green component directly illuminates an LCLV 112G.

Though such design may make the angle of incidence of a incoming beam to the dichroic coating less steep, the twice reflections for both the red and blue components and the obliquely transmission of the air gap for the blue and green components may result in a color deviation. Further, the long back focal length due to such optical arrangement is also disadvantageous.

FIG. 8 shows a color projection display 200 incorporating a cross dichroic prism (X-cube) 204. The X-cube 204 is constructed by cross dichroic coatings 204a, 204b, 204c, and 204d as shown by diagonal lines of a quadrangular cross section. The dichroic mirror 204a and the dichroic mirror 204d reflect only the blue component; the dichroic mirror 204b and the dichroic mirror 204c reflect only the red component. Liquid crystal panels 208R, 208G, and 208B of the reflection type corresponds to their respective light components red, green, and blue. The prism 204 separates the white light into the light components red, green, and blue and reflects by the first to third liquid crystal panels 208R, 208G, and 208B, thereby synthesizing the emitted light components. On the other hand, a projection lens 206 is arranged in the direction opposite to the reflecting direction by the polarizing beam splitters 202a and 202b of the white light. The P polarizing component of the synthetic light which was synthesized by the cross dichroic prism 204 is transmitted through the polarizing beam splitters 202a and 202b and, after that, it passes through the projection lens 206 and is projected onto a screen (not shown).

Such projection system may shorten the back focal length and eliminate the disadvantage of the Philips prism 100 mentioned above; however, the angle of incidence of a incoming beam to the dichroic coating is as large as 45 degrees to considerably deteriorate energy efficiency and the color purity after separation, thus lowering the overall performance of the projection system.

### BRIEF SUMMARY OF THE INVENTION

An object of the invention is to provide a color separation prism assembly that is able to solve the aforesaid problems existing in conventional designs.

According to the invention, the color separation prism assembly includes a first and a second prism blocks. The first prism block has a first and second prism faces adjacent to each other, and the first and second prism faces are respectively formed with a first and a second dichroic coatings through which a light beam sequentially travels. The first dichroic coating filters out a first light component of the light beam, and the second dichroic coating filters out a second light component and transmits a third light component of the light beam. The first prism block also has a third prism face constructed to make the third light component be perpendicularly transmitted therethrough. The second prism block is in contact with the first and second prism faces of the first prism block, and the second prism block has a first prism face for reflecting the first light component and a second prism face constructed to make the first light component be perpendicularly transmitted therethrough. The second prism block also has a third prism face constructed to make the third light component be perpendicularly transmitted therethrough. All the first, second and third light components travel in the prism assembly have equal optical path lengths.

Through the design of the invention, the prism assembly can not only reduce the optical path lengths of all light components to shorten the back focal length, but assure the angles of incidence to the dichroic coatings are restricted within no more than 30 degrees to enhance energy efficiency and the color purity. Further, since no air gap exists in the prism assembly, the obliquely transmission of the air gap for the light components no longer occurs; in addition, the number of times the light components are reflected also decreases. These all improve the image accuracy of the prism assembly according to the invention.

### BRIEF DESCRIPTION OF THE DRAWINGS

FIG. 1A shows a schematic diagram of a prism assembly in accordance with an embodiment of the invention.

FIG. 1B shows a perspective view illustrating a triangular prism (a), a right-angle prism (b), and a quadrangular prism (c).

FIG. 2 shows an optical arrangement of prisms based on the embodiment shown in FIG 1A.

FIG. 3 shows a schematic diagram of a prism assembly in accordance with another embodiment of the invention.

FIG. 4 shows an optical arrangement of prisms based on the embodiment shown in FIG. 3.

FIG. 5 and FIG. 6 shows schematic diagrams of a prism assembly in accordance with modifications of the invention.

FIG. 7 shows a schematic diagram of conventional Philips prism.

FIG. 8 shows a schematic diagram of a color projection display incorporating a cross dichroic prism.

### DETAILED DESCRIPTION OF THE INVENTION

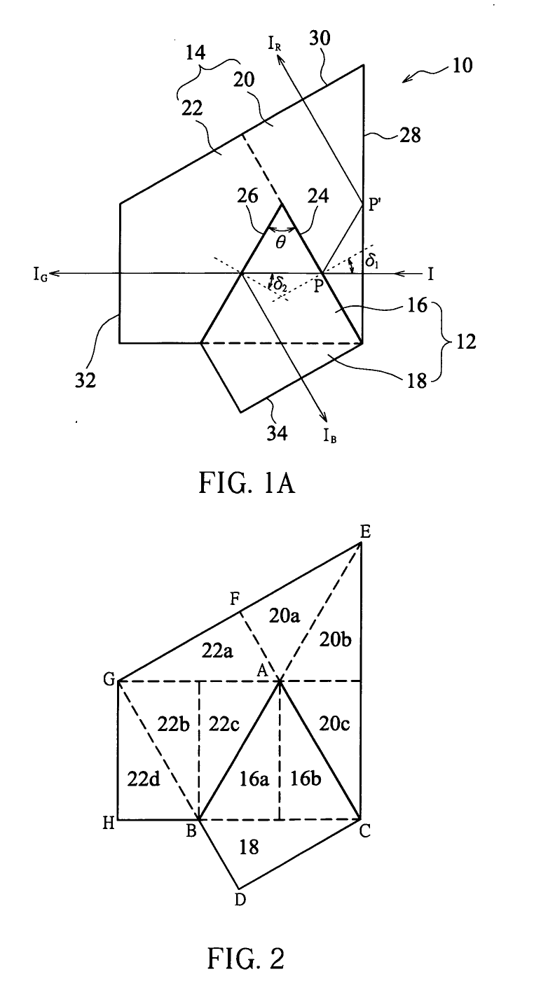

FIG. 1A shows a schematic diagram of a prism assembly 10 in accordance with an embodiment of the invention for separating a light beam into several colored light components, such as red, blue and green components.

According to this embodiment, the prism assembly 10 is comprised of two prism blocks 12 and 14. The prism block 12 is in a shape of a quadrangular prism that may be constructed by a combination of a triangular prism 16 and a right-angle prism 18. FIG. 1B shows a perspective view illustrating a triangular prism (a), a right-angle prism (b) and a quadrangular prism (c). It should be noted that, as used in this description and in the appended claims, the word “triangular prism” means a prism having a pair of parallel faces and three side faces perpendicular to the parallel faces. Similarly, the word “quadrangular prism” means a prism having a pair of parallel faces and four side faces perpendicular to the parallel faces, and so on. Further, the incoming light I enters the prism assembly by its side face, as shown in FIG. 1B.

Referring back to FIG. 1A, interference films that selectively reflect colors in two substantially non-overlapping wavelength ranges are deposited on two lateral faces with an included angle θ of the triangular prism 16 to form two dichroic coatings 24 and 26, and the base face of the triangular prism 16 without the formation of the dichroic coating neighbors the hypotenuse face of the right-angle prism 18.

Hence, since the dichroic coatings 24 and 26 are formed on two lateral faces of the triangular prism 16, the optical path lengths of the light components may be shortened, and the angle of incidence to the dichroic coating is easy to manage.

The prism block 14 is constructed by a right-angle prism 20 and a pentagonal prism 22, with their faces respectively touching the dichroic coatings 24 and 26 to closely connect the prism block 14 to the prism block 12, thus forming a hexahedron prism shaped like a cut-diamond.

Referring to FIG 1A, as the incoming light I is incident on the dichroic coating 24 at an angle δ₁, the red component is reflected and filtered out by the dichroic coating 24. The prism block 14 is constructed so that the hypotenuse face 28 of the right-angle prism 20 may function as a reflecting surface with respect to the red component. Thereby, the red component is reflected at point P′ and exits the right-angle prism 20 by its face 30 in a direction perpendicular to the face 30.

Subsequently, the incoming light I with the remaining light components is incident on the dichroic coating 26 at an angle δ₂, and its blue component is reflected and filtered out by the dichroic coating 26 while the green component passes through the dichroic coating 26 without refraction. The prism block 14 is constructed so that the green component may exit the pentagonal prism 22 in a direction perpendicular to its face 32, and the prism block 12 is constructed so that the reflected blue component may exit the right-angle prism 18 by its face 34 in a direction perpendicular to the face 34.

The design of the prism blocks can make the optical path lengths of the red, blue and green components equal and allow the color components to exit the prism assembly 10 in a direction perpendicular to its respective faces.

Typically, the reflectivities and transmissivities of the dichroic coatings 24 and 26 may differ for the two polarizations of the incoming light I, because the incoming light I is not perpendicularly incident on the dichroic coatings. Further, as the incidence angle becomes larger, the color deviation due to the spectral curve shift becomes more apparent.

Hence, it is preferable that the angle of incidence to the dichroic coating is no more than 30 degrees. Under the circumstance, the angle θ formed by the two lateral faces of the triangular prism 16 is set at 60 degrees such that the angle of incidence to the dichroic coating is easy to be confined to no more than 30 degrees.

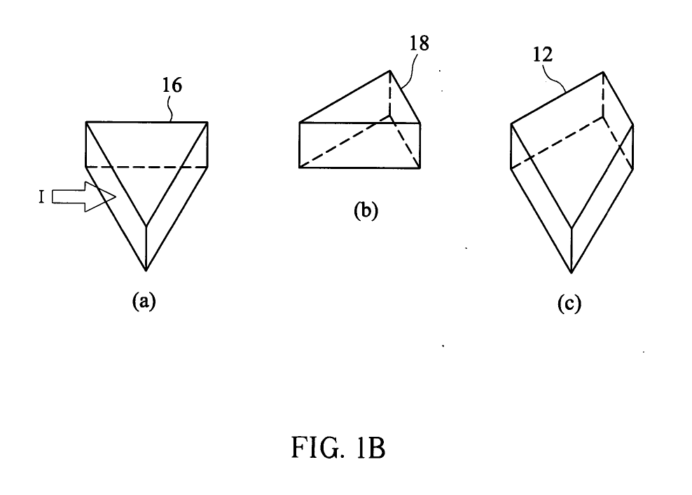

FIG. 2 shows an optical arrangement of prisms based on the embodiment given above. Referring to FIG. 2, the prism assembly may consist of a plurality of identical sub prisms. The sub prism, according to this embodiment, is a right-angle prism having angles of 30 degrees, 60 degrees and 90 degrees (hereinafter referred to as a 30°-60°-90° prism). The right-angle prism 20 of the prism block 14 may consist of three sub prisms 20a, 20b and 20c, and the pentagonal prism 22 may consist of four sub prisms 22a, 22b, 22c and 22d. The triangular prism 16 may be an equilateral triangle prism consisting of two sub prisms 16a and 16b, with their hypotenuse faces coated with dichroic coatings. Also, the right-angle prism 18, identical with the 30°-60°-90° prism mentioned above, neighbors the base faces of the sub prism 16a and 16b via its hypotenuse face. Through such architecture formed by the plurality of identical 30°-60°-90° prisms, the prism assembly according to the invention can not only reduce the optical path lengths of all light components to shorten the back focal length, but assure the angles δ₁ and δ₂ of incidence to the dichroic coatings are restricted within no more than 30 degrees to enhance the color purity. Further, since no air gap exists in the prism assembly, the obliquely transmission of the air gap for the light components no longer occurs; in addition, the number of times the light components are reflected also decreases. These all improve the image accuracy of the prism assembly according to the invention.

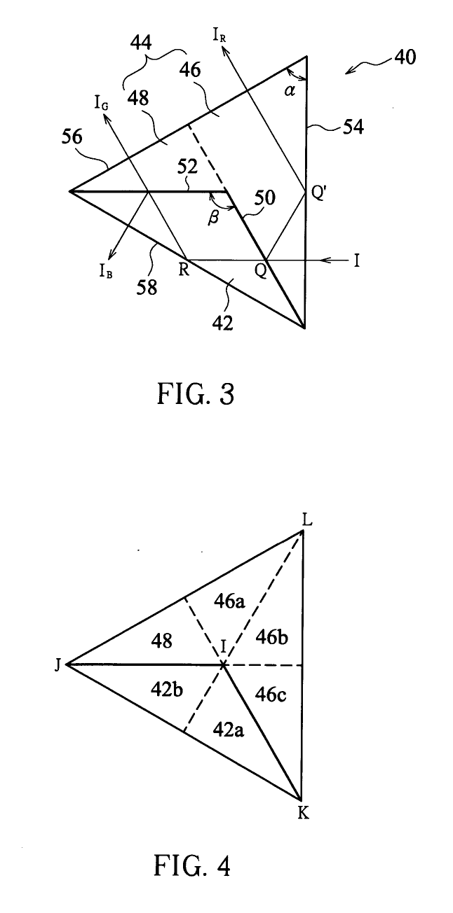

Referring to FIG. 3, the prism assembly 40 according to another embodiment is comprised of two prism blocks 42 and 44 cemented together. The prism block 42 is a triangular prism having two equal lateral faces on which two dichroic coatings 50 and 52 are respectively applied. The prism lock 44 is constructed by two right-angle prisms 46 and 48. In this embodiment, the included angle β between two equal lateral faces of the prism block 42 is twice as large as the vertex angle α of the prism assembly 40. It is preferred that the vertex angle α is set as 60 degrees and thus β equals 120 degrees.

According to this embodiment, as the incoming light I is incident on the dichroic coating 50 at point Q, the red component is reflected and filtered out by the dichroic coating 50. The prism block 44 is constructed so that the hypotenuse face 54 of the right-angle prism 46 may function as a reflecting face with respect to the red component. Thereby, the red component are reflected at point Q′ and exits the right-angle prism 46 by its face 56 in a direction perpendicular to the face 56.

Subsequently, the incoming light I with the remaining light components is incident on the face 58 of the prism block at point R, and its blue component is reflected and filtered out by the dichroic coating 52 while the green component passes through the dichroic coating 52 without refraction. The prism block 44 is constructed so that the red and green components exit the prism assembly 40 in a direction perpendicular to the face 56, and the prism block 42 is constructed so that the reflected blue component exits the prism block 42 by its face 58 in a direction perpendicular to the face 58.

FIG. 4 shows an optical arrangement of prisms based on the embodiment given above. Referring to FIG. 4, the prism assembly 40 may consist of a plurality of identical sub prisms having angles of 30 degrees, 60 degrees and 90 degrees. The right-angle prism 46 of the prism block may be a 30°-60°-90° prism consisting of three sub prisms 46a, 46b and 46c, and the prism block 42 is an isosceles triangle prism consisting of sub prisms 42a and 42b, with their hypotenuse faces applied with dichroic coatings. Also, the right-angle prism 48 is constructed by the same sub prism. All sub prisms are combined together to form the prism assembly 40 shaped as a equilateral triangle prism.

In this embodiment, though the reflection number is increased by one (reflection with respect to the face 58 of the prism block 42) compared to the above embodiment, the occupied space of the prism assembly 40 is reduced.

In view of the fact that the interference films are very sensible to the angle of incidence, it's better to minimize the angle of incidence to the utmost so as to enhance the color purity. Hence, another embodiment that provides reduced angle of incidence to the dichroic coating is described below.

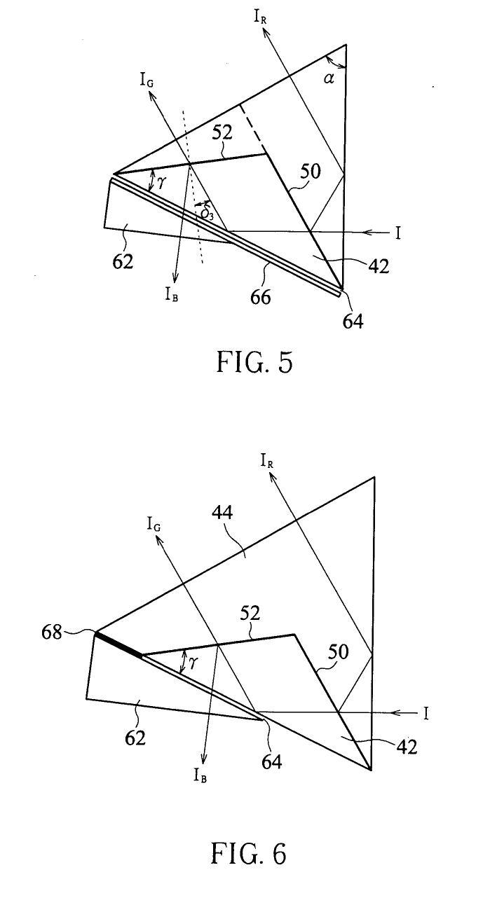

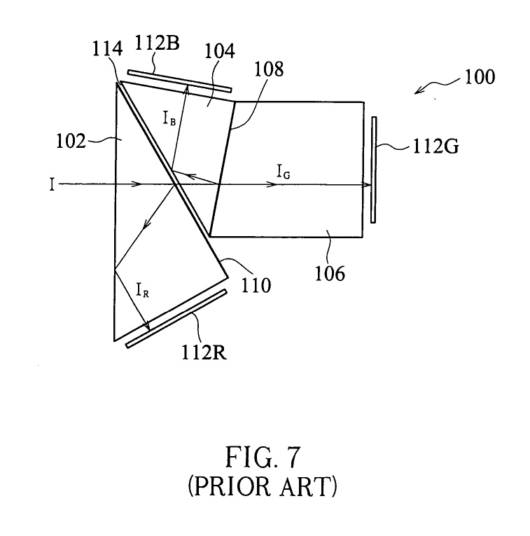

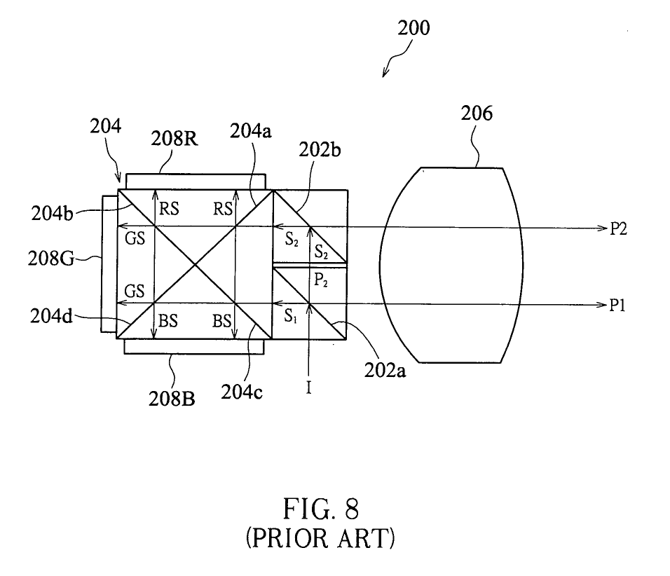

First, referring to the geometry shown in FIG. 5, as the angle γ, formed between the base face and the prism face with dichroic coating 52 of the prism block 42, is increased, the angle of incidence δ₃ to the dichroic coating is decreased. Hence, in case that the vertex angle α equals 60 degrees, the angle of incidence δ₃ is restricted to less than 30 degrees as the angle γ is set more than 30 degrees. That is, the angle of incidence δ₃ is restricted to less than 30 degrees only by changing the shape of the prism block 42 to decrease the angle γ. Further, it should be noted that, as the angle γ is decreased, an additional prism block 62 is needed to compensate the optical path length of the blue component so as to maintain the equal lengths of three light components. Preferably, the prism block 62 may be a right-angle prism such that a prism face constructed to make the blue component be perpendicularly transmitted therethrough is easy to be provided.

Referring to FIG. 5, the prism block 62 may be cemented on a transparent plate 66 via its hypotenuse face, and the transparent plate 66 is spaced apart from the prism block 42 with an air gap. Alternatively, an adhesive 68 may be directly applied on the end portion of the hypotenuse face of the prism block 62 to maintain an air gap between the prism block 62 and the prism block 42, as in FIG. 6.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A color separation prism assembly, comprising:
a first prism block having a first face, a second face and a third face, the first and second faces being adjacent to each other and respectively formed with a first and a second filters through which a light beam sequentially travelling, the first filter filtering out a first light component of the light beam, the second filter filtering out a second light component and transmitting a third light component of the light beam, and the third face enabling the third light component to perpendicularly transmit therethrough; and
a second prism block coupled with the first and second faces of the first prism block, the second prism block having a first face for reflecting the first light component, a second face enabling the first light component to perpendicularly transmit therethrough, and a third face enabling the third light component to perpendicularly transmitted therethrough;
wherein the first, second and third light components travelling in the prism assembly have equal optical path lengths.

2. The color separation prism assembly as recited in claim 1, wherein the first and second prism blocks are combined to form a hexahedron prism.

3. The color separation prism assembly as recited in claim 1, wherein the first prism block is a quadrangular prism constructed by a triangular prism and a right-angle prism, the first and the second filters being applied on two prism faces of the triangular prism and the hypotenuse face of the right-angle prism being in contact with the triangular prism.

4. The color separation prism assembly as recited in claim 3, wherein the triangular prism is an equilateral triangle prism.

5. The color separation prism assembly as recited in claim 1, wherein the second prism block is constructed by a pentagonal prism and a right-angle prism, the first face being the hypotenuse face of the right-angle prism and the third face being one prism face of the pentagonal prism.

6. The color separation prism assembly as recited in claim 1, wherein the angle between the first and second faces in the first prism block is 60 degrees.

7. The color separation prism assembly as recited in claim 6, wherein the first prism block is constructed by three identical 30°-60°-90° prisms.

8. The color separation prism assembly as recited in claim 6, wherein the second prism block is constructed by a pentagonal prism and a right-angle prism, the pentagonal prism being constructed by four identical 30°-60°-90° prisms and the right-angle prism being constructed by three identical 30°-60°-90° prisms.

9. The color separation prism assembly as recited in claim 1, wherein the first and second filters are interference films applied on the prism face.

10. The color separation prism assembly as recited in claim 1, wherein the first and second prism blocks are cemented together.

11. A color separation prism assembly, comprising:
a first prism block having a first face, a second face and a third faces, the first and second faces being adjacent to each other and respectively formed with a first and a second filters through which a light beam sequentially travelling, the first filter filtering out a first light component of the light beam, the second filter filtering out a second light component and transmitting a third light component of the light beam, and the third face being constructed to reflect the second and third light components and enabling the second light component to perpendicularly transmitted therethrough; and
a second prism block couple with the first and second prism faces of the first prism block, the second prism block having at least a first face for reflecting the first light component, a second face enabling the first and third light components to perpendicularly transmitted therethrough;
wherein the first, second and third light components travelling in the prism assembly have equal optical path lengths.

12. The color separation prism assembly as recited in claim 11, wherein the first and second filters are interference films applied on the prism face.

13. The color separation prism assembly as recited in claim 11, wherein the first and second prism blocks are combined to form an equilateral triangle prism, with the angle between the first and second faces in the second prism block being 60 degrees.

14. The color separation prism assembly as recited in claim 13, wherein the first prism block is constructed by two identical 30°-60°-90° prisms.

15. The color separation prism assembly as recited in claim 13, wherein the second prism block is constructed by four identical 30°-60°-90° prisms.

16. The color separation prism assembly as recited in claim 11, wherein the first and second prism blocks are cemented together.

17. The color separation prism assembly as recited in claim 11, wherein the first prism block is a triangular prism with two equal lateral faces, the vertex angle of the triangular prism being twice as large as the angle between the first and second faces in the second prism block.

18. A color separation prism assembly, comprising:
a first prism block having a first face, a second face and a third face, the first and second faces being adjacent to each other and respectively formed with a first and a second filters through which a light beam sequentially travelling, the first filter filtering out a first light component of the light beam, the second filter filtering out a second light component and transmitting a third light component of the light beam, the third face being constructed to reflect the second and third light components and enabling the second light component to perpendicularly transmit therethrough, and the angle between the second and third faces being larger than 30 degrees;
a second prism block coupled with the first and second faces of the first prism block, the second prism block having a first face for reflecting the first light component, a second face enabling the first and third light components to perpendicularly transmit therethrough, and the angle between the first and second prism faces being 60 degrees; and
a third prism block spaced apart from the first prism block with an air gap, the third prism block having a face enabling the second light component to perpendicularly transmit therethrough;
wherein the first, second and third light components travelling in the prism assembly have equal optical path lengths.

19. The color separation prism assembly as recited in claim 18, wherein the third prism block is a right-angle prism and the face transmitting the second light component is the hypotenuse face of the right-angle prism.

20. The color separation prism assembly as recited in claim 19, wherein the right-angle prism is mounted on a plate via its hypotenuse face and the plate is spaced apart from the first prism block with an air gap.

21. The color separation prism assembly as recited in claim 19, wherein an adhesive is applied between the end portion of the hypotenuse face of the right-angle prism and the first prism block.
